(19) United States
(12) Patent Application Publication
(10) Pub. No.: US 2003/0132066 A1
(43) Pub. Date: Jul. 17, 2003

(54) Brake for an open-end spinning rotor

(76) Inventor: Heinz-Georg Wassenhoven, Monchengladbach (DE)

Correspondence Address: KENNEDY COVINGTON LOBDELL & HICKMAN, LLP, 100 NORTH TRYON STREET, BANK OF AMERICA CORPORATE CTR. SUITE 4200, CHARLOTTE, NC, 28202, US

(21) Appl. No.: 10/119,792

(22) Filed: Apr. 10, 2002

(30) Foreign Application Priority Data
Apr. 10, 2001 (DE) 101 17 921.9

(51) Int. Cl. F16D 55/08

(52) U.S. Cl. 188/72.1

(57) ABSTRACT

A brake (8) for a high speed open-end spinning rotor rotatably supported by its rotor shaft (2) in the bearing nip (3) of a support disk bearing (4). The rotor brake comprises tong arms that can be placed on the rotor shaft (2), each arm carrying a replaceable brake lining (16) on its end. The brake lining (16) is securely but removably fastened to the tong arm (9, 10) via a clamping plate (17) having a profiling (24) and loaded by a screw bolt (14).

### CROSS-REFERENCE TO RELATED APPLICATIONS

This application claims the benefit of German patent application 10117921.9 filed Apr. 10, 2001, herein incorporated by reference.

### BACKGROUND OF THE INVENTION

The present invention relates to a brake for an open-end spinning rotor, especially a high speed open-end spinning rotor rotatably supported by its rotor shaft in the bearing nip of a support disk bearing. More particularly, the present invention relates to such a brake comprising tong arms having a replaceable brake lining engagable on the rotor shaft for actuating braking action of the rotor.

Open-end rotor spinning devices with brake devices acting on the rotor shaft of a spinning means are known in various embodiments and have long been recognized to represent the existing state of the art.

For example, German Patent Publication DE 38 20 328 C2 describes a rotor brake with tong arms arranged in mirror symmetry, each of which comprises an asbestos-free brake lining on the end. When the rotor brake is actuated these brake linings are placed on the rotor shaft at the same time, thus braking the spinning rotor from its high speed rotation during the spinning operation rapidly and reliably to a standstill.

However, the service life of the brake linings of such rotor brakes is quite limited due to their high load. That is, the frictional heat produced during the braking process allows the brake linings, which typically comprise a fiber-reinforced, asbestos-free and solvent-free material containing metal and bound with artificial resin, to become glassy over time in the area of their point of contact with the rotor shaft.

Since such glassy brake linings negatively influence the operation of the rotor brake, especially by significantly lengthened braking times, the brake linings are arranged to be replaceable. That is, the brake linings are fixed by a positive connection to the tong arms in such a manner that they can be replaced as required by new brake linings. The brake linings each have an approximately central bore through which a screw bolt extends. Moreover, the screw bolt, that is mounted in a bore of the tong arm, corresponds to a threaded bore in a counterelement, preferably a screw nut.

However, this type of fastening has the disadvantage that when the brake linings are replaced, the screw bolts must also always be removed, which signifies a significant amount of work in an open-end rotor spinning machine with a plurality of work stations and two brake linings per work station.

In order to increase the stability and therewith the service life of rotor brakes, it has already been suggested that such brake linings be manufactured from a carbon-fiber composite material or of sintered bronze.

As described, e.g., in German Patent Publication DE 198 02 655 A1, such brake linings manufactured from a carbon-fiber composite material have the great advantage that they are extremely resistant to temperature changes, have a very high resistance to wear and that surface changes in the area of the braking surface do not occur even after a rather long running time.

The known brake linings of carbon-fiber composite material are preferably designed as symmetric components that have two or even three braking surfaces that can be used sequentially as required. The brake linings are either fixed in special brake-lining holders or, similar to the brake linings of asbestos-free material, positively fixed to the tong arms by a screw bolt and a central bore.

Even in these known rotor brakes the type of fastening of the brake linings to the tong arms has not been completely satisfactory.

Moreover, subsequently published German Patent Application P 101 00 524.5 teaches a rotor brake in which the brake linings are manufactured from sintered bronze. Although such brake linings in sintered bronze have an extremely long service life, these known brake linings are also replaceably arranged on the tong arms. The brake linings comprise a downwardly open slot with which they can be thrust over a screw bolt mounted on the tong arm. The brake linings can be disengaged as needed by simply loosening the screw bolt and then drawing them gently from their support seat on the tong arm and replacing them with a new brake lining. After the new brake lining has been installed, one need merely re-tighten the screw bolt.

This type of fastening has proven itself in the case of brake linings manufactured from a relatively pressure-resistant material such as, e.g., sintered bronze; however, in the case of brake linings with material that is not as pressure-resistant such as, e.g., carbon-fiber composite material, this type of fastening has not proven to be optimal.

### SUMMARY OF THE INVENTION

It is accordingly an object of the present invention to improve the previously cited state of the art of rotor brakes for open-end spinning machines, and in particular to improve the fastening of brake linings to the tong arms.

The invention addresses this problem by providing a brake adapted for an open-end spinning rotor rotating at a high speed in a rotor housing, wherein the rotor is rotatably supported by its rotor shaft in the bearing nip of a support disk bearing. The brake comprises tong arms having a replaceable brake lining engagable on the rotor shaft for actuating braking action and, in accordance with the present invention, the brake lining is fixed to the tong arm by a clamping plate loaded by a screw bolt, with the clamping plate having a defined profiling.

The brake of the present invention has the particular advantage that, on the one hand, the brake linings can be readily replaced as needed and, on the other hand, are reliably fixed to the tong arms during operation, that is, during the numerous braking processes of the rotor brake. The profiling arranged on the clamping plate maximizes the adhesion between the clamping plate and the brake lining and thereby assures that relative movements between the clamping plate and the brake lining, that would significantly adversely affect the rotor brake, are prevented.

An advantageous embodiment provides that the clamping plate and the brake lining are manufactured from materials with differing pressure resistances. The clamping plate is preferably manufactured from a material, e.g., steel, that has a distinctly greater pressure resistance that the material of the brake lining. A non-metallic material, e.g., a plastic, is used with advantage as material for the brake lining.

In a preferred embodiment, the brake linings are manufactured from a chemical-fiber composite material since such a material, as already explained above, is extremely resistant to temperature changes and also has a very great wear resistance. For example, carbon-fiber composite materials, glass-fiber composite materials or aramid-fiber composite materials have proven to be especially suitable for the manufacture of brake linings.

Preferably, the clamping plate is loaded by the screw bolt in a manner such that the profiling of the clamping plate is pressed into a surface of the brake lining for producing a positive connection therebetween. This design renders it possible to lower the profiling of the clamping plate somewhat in the surface of the less pressure-resistant material of the brake lining by tightening the screw bolt mounted on the tong arm, thus producing a quasi positive connection.

In a preferred embodiment, the brake lining comprises a downwardly open fastening slot through which a screw bolt extends in the assembled state into a correspondingly threaded bore in the clamping plate. Thus, the brake lining can simply be drawn up from its support seat on the tong arm, if required, after loosening the screw bolt, during which the screw bolt and the profiled clamping plate remain in their installed position. The installation of the new brake lining is just as simple. In this instance, the new brake lining with its fastening slot is lowered from above over the screw bolt. The screw bolt is subsequently re-tightened by an appropriate tool.

Further details, features and advantages of the present invention will be understood from an exemplary embodiment described in the following disclosure with reference to the accompanying drawings.

### BRIEF DESCRIPTION OF THE DRAWINGS

FIG. 1 is a schematic cross-sectional view of an open-end rotor spinning device with a rotor brake in accordance with the present invention, wherein each of the tong arms comprises a brake lining secured by a profiled clamping plate.

FIG. 2 is a perspective view, on a larger scale than FIG. 1, of a tong arm with a brake lining arranged on one end and a clamping plate in accordance with the present invention.

FIG. 3 is a perspective view similar to FIG. 2 but showing the tong arm thereof in an exploded view.

FIG. 4 is an enlarged perspective view of the clamping plate in accordance with the present invention.

### DESCRIPTION OF THE PREFERRED EMBODIMENT

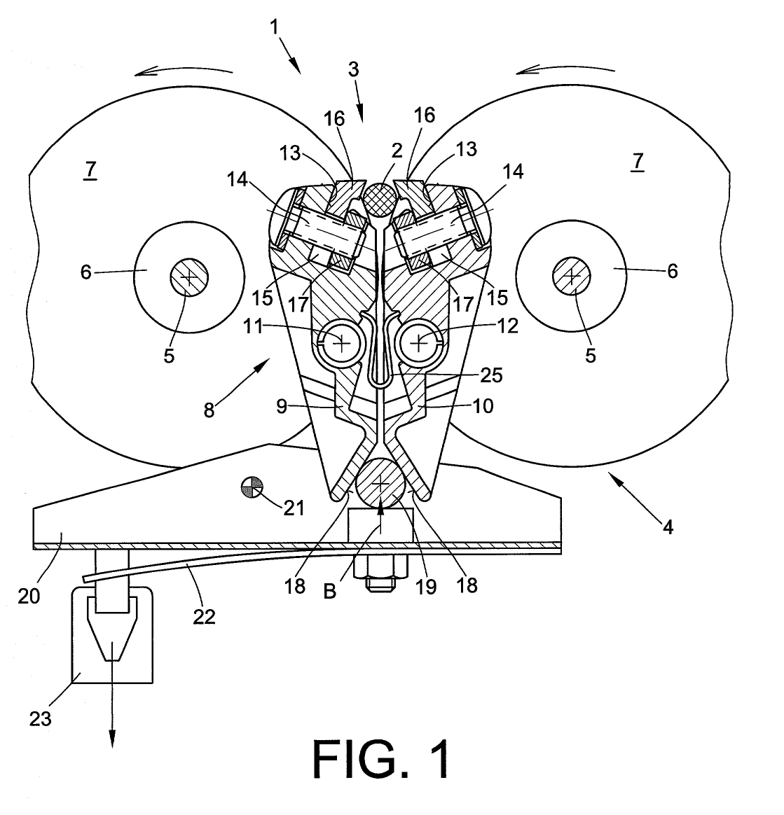

Referring now to the accompanying drawings and initially to FIG. 1, an open-end rotor spinning device 1 is schematically represented of the type having a known spinning means, a so-called spinning rotor (not shown in more detail), rotatably supported by its rotor shaft 2 in the support nip 3 of a support disk bearing 4.

Such a support disk bearing 4 has long been known in conjunction with an open-end rotor spinning device, and generally comprises two identical support disk pairs with front and rear support disks 7. The two support disks 7 are connected via shafts 5 in such a manner that they can rotate in unison and are themselves rotatably supported in roller bearings 6.

As FIG. 1 indicates, rotor brake 8 is of a tong-like configuration such that it can be moved into braking engagement with rotor shaft 2. The two tong arms 9, 10 of rotor brake 8 each have brake lining 16 on their ends, and are arranged as brake levers that are rotatably supported for a limited degree of pivoting movement in pivot shafts 11, 12 toward and away from the rotor shaft 2, with an interposed spring element 25 acting between the brake levers to urge them normally into an open non-braking position.

Brake levers 9, 10 each have a sliding surface 18 on their ends opposite brake lining 16. Sliding surfaces 18 converge toward one another in the assembled condition of the brake. A preferably roller-like pressure element 19 engages sliding surfaces 18. This pressure element is supported so that it can shift in direction B to load brake levers 9, 10 against the force of spring element 25 at the same time they are moved toward one another into an active braking position.

Pressure element 19 is preferably fastened between the side walls of U-shaped actuation lever 20 that, as is known, is supported such that it can pivot in a limited manner about pivot shaft 21. In addition, leaf spring 22 is fastened to actuation lever 20 and comprises catch ring 23 on one end. An actuation linkage (not shown) acts on this catch ring 23, which linkage is loaded in case of service by a movable service unit, e.g., a so-called spinning-start carriage, that automatically supplies the open-end rotor spinning devices.

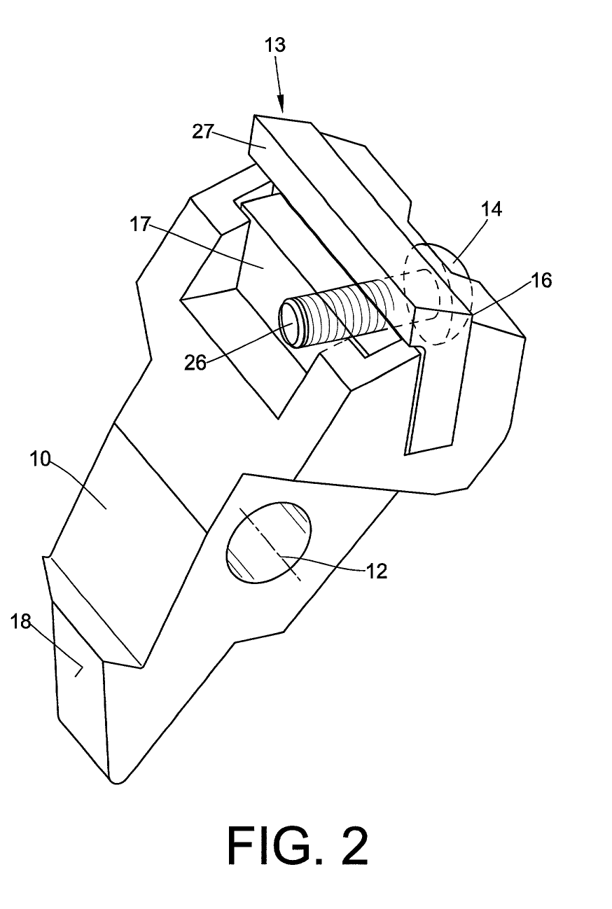

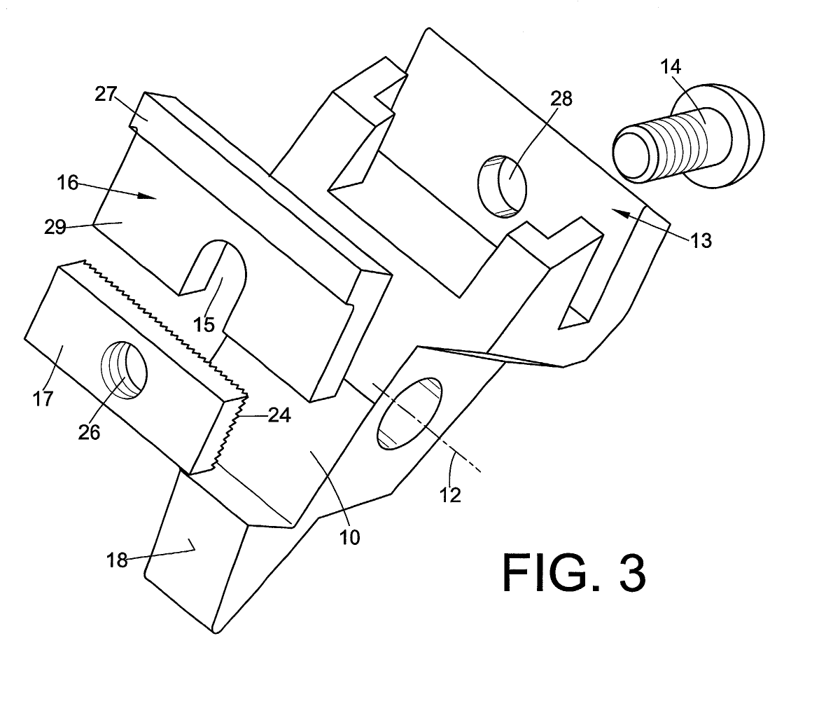

As FIGS. 2 and 3 show, tong arms 9, 10 each comprise support site 13 for a brake lining 16, preferably a brake lining 16 manufactured from a carbon-fiber composite material, that can also be replaced if needed and can be fixed in these support sites 13 by screw bolt 14 and by clamping plate 17 comprising threaded bore 26.

As FIG. 3 in particular shows, brake lining 16 is substantially rectangular as viewed from the front. The upper area of brake lining 16, that is, the area that is placed on rotating rotor 2, functions as brake surface 27 and is dimensioned somewhat thicker.

Downwardly open fastening slot 15 is formed on the bottom of brake lining 16. This fastening slot 15 engages in the mounted state over screw bolt 14 supported in bore 28 of tong arm 10 which bore corresponds with threaded bore 26 in clamping plate 17.

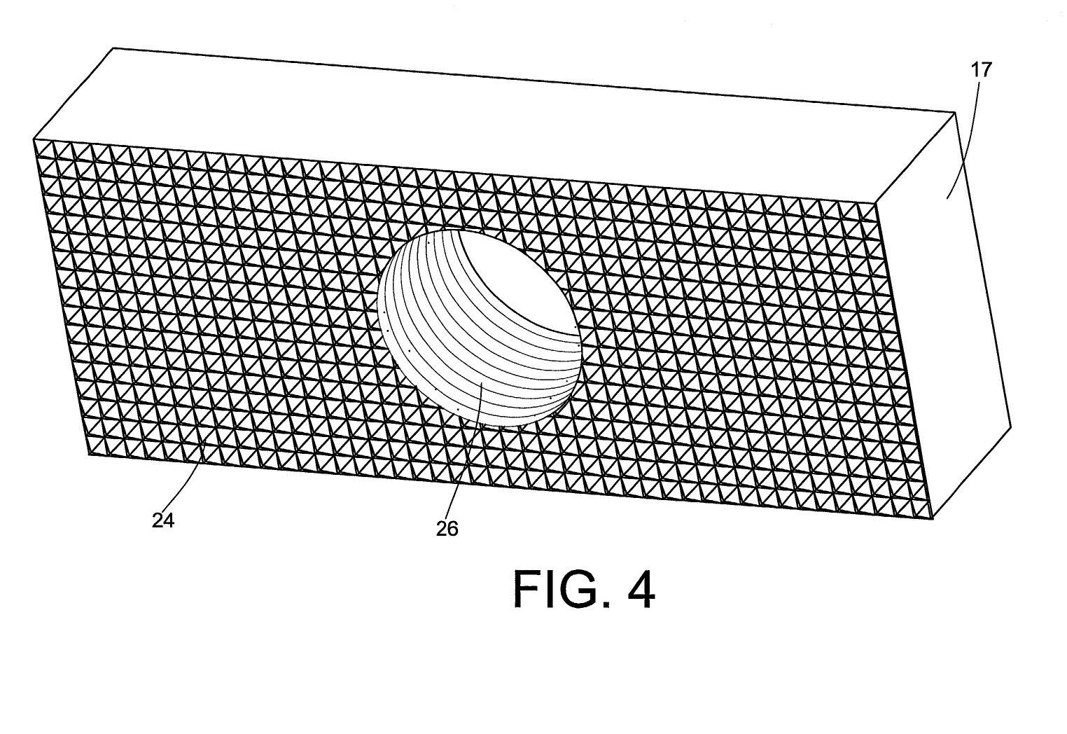

Clamping plate 17 also comprises a profiling 24, as FIG. 4 in particular shows, that loads surface 29 of brake lining 16 in the mounted state. That is, when screw bolt 14 is tightened, clamping plate 17 is pressed with its profiling 24 in such a manner against surface 29 of brake lining 16 that profiling 24 sinks somewhat into surface 29 of brake lining 16 and brake lining 16 is fixed therewith via clamping plate 17 quasi-positively on tong arm 10.

Brake lining 16 can nevertheless be readily removed from the particular support site 13, if required, on account of its downwardly open fastening slot 15 and replaced, if necessary, by a new brake lining 16.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. A brake for an open-end spinning rotor rotating at a high speed in a rotor housing, wherein the rotor is rotatably supported by its rotor shaft in the bearing nip of a support disk bearing, the brake comprising tong arms having a replaceable brake lining engagable on the rotor shaft for actuating braking action, the brake lining being fixed to the tong arm by a clamping plate loaded by a screw bolt, the clamping plate having a defined profiling.

2. The brake according to claim 1, characterized in that the clamping plate is formed of a material having a greater pressure resistance that a material of the brake lining.

3. The brake according to claim 2, characterized in that the brake lining comprises a chemical-fiber composite material.

4. The brake according to claim 3, characterized in that the brake lining comprises a carbon-fiber composite material.

5. The brake according to claim 3, characterized in that the brake lining comprises a glass-fiber composite material.

6. The brake according to claim 3, characterized in that the brake lining comprises an aramid-fiber composite material.

7. The brake according to claim 1, characterized in that the clamping plate is loaded by the screw bolt in a manner such that the profiling of the clamping plate is pressed into a surface of the brake lining for producing a positive connection therebetween.

8. The brake according to claim 1, characterized in that the brake lining comprises a downwardly open fastening slot through which the screw bolt extends.

9. The brake according to claim 1, characterized in that the clamping plate comprises a threaded bore that corresponds with the screw bolt.
